(19) United States
(12) Patent Application Publication
(10) Pub. No.: US 2006/0113315 A1
(43) Pub. Date: Jun. 1, 2006

(54) Slide dispenser

(76) Inventor: Aili Chen, Rancho Palos Verdes, CA (US)

Correspondence Address: Raymond Y. Chan, 108 N. Ynez Ave., #128, Monterey Park, CA, 91754, US

(21) Appl. No.: 11/178,168

(22) Filed: Jul. 7, 2005

(30) Foreign Application Priority Data
Dec. 1, 2004 (CN) 2004200989627

(51) Int. Cl. B65G 59/00

(52) U.S. Cl. 221/268

(57) ABSTRACT

A slide dispenser for a stack of slides includes a slide container and a slide dispensing unit. The slide container has a slide opening and an actuation opening formed on two bottom side portions of the slide container respectively. The slide dispensing unit includes a dispensing housing which includes two sidewalls defining two sliding tracks respectively, and an actuation unit which includes a sliding member slidably mounted on the dispensing housing at the two sliding tracks. The sliding member has a pusher latch upwardly extended from a top surface of the sliding member for slidably engaging with the actuation opening of the slide container. The dispensing housing further includes a resilient element mounted therein for normally exerting an urging force on the sliding member to normally retain the sliding member at an idle position.

### FIELD OF INVENTION

The present invention relates to slides, and more particularly to a slide dispenser which is capable of storing a stack of slides in a hygienic condition while allowing easy retrieval of the slides.

### DESCRIPTION OF RELATED ARTS

Slides, such as microscope slides, are widely utilized in various laboratories and hospitals for in-depth inspection of various specimens. As a matter of conventional practice, the slides are first sanitized before any specimen is placed thereon. However, for those sanitized slides, there is no specifically designed container to store them so that they may be placed simply in regular containers. As such, there is high risk that those sanitized slides are re-polluted by dirt or re-infected by unwanted micro-organisms or virus in a typical laboratory or hospital environment. The consequence is that if those re-polluted or re-infected slides are subsequently utilized as if they were really sanitized, the result of the examination of the specimen will contain substantial amount of error. As a matter of fact, there exist some containers alleged to be specifically designed for containing sanitized slides, but the problems is that almost all of those containers do not cater for easy retrieval of the slides so that it is impractical for use in typical laboratory and hospital environment.

### SUMMARY OF THE PRESENT INVENTION

A main object of the present invention is to provide a slide dispenser which is capable of storing a stack of slides in a hygienic environment while allowing easy retrieval of the slides.

Another object of the present invention is to provide a slide dispenser which is capable of dispensing a slide from a slide container without substantially affecting other slides, so that those sanitized slides containing in the slide container can be keep in a maximum hygienic condition.

Another object of the present invention is to provide a slide dispenser, wherein the slide container is adapted to store a stack of slides which are kept separate from ambient environment in which the slide dispenser is utilized, so as to minimize the possibility of the slides being re-polluted or re-infected by unwanted substances, micro-organisms or viruses.

Another object of the present invention is to provide a slide dispenser which is easy to use and facilitates convenient refilling of the slides, so as to allow widespread application of the present invention.

Another object of the present invention is to provide a slide dispenser which does not involve complicated and expensive mechanical components so as to minimize the manufacturing cost of the present invention.

Another object of the present invention is to provide a slide dispensing unit for a slide container, wherein the slide dispensing unit normally engages with a slide of the slide container, and is capable of dispensing the slide therefrom without substantially affecting other slides, so that any sanitized slides containing in the slide container can be keep in a maximum hygienic condition.

Accordingly, in order to accomplish the above objects, the present invention provides a slide dispenser for a stack of slides, comprising:

a slide container having a receiving cavity for receiving the stack of slides in an overlapped manner, and a dispensing channel communicating with the receiving cavity for allowing the slide at a bottommost to slide along the dispensing channel; and

a slide dispensing unit, which comprises:

a dispensing housing for detachably supporting the slide container thereon; and

an actuation unit which comprises a sliding member slidably mounted on the dispensing housing to communicate with the dispensing channel, and a slide actuator movably connected to the dispensing housing to move the sliding member between an idle position and a dispensing position, wherein at the idle position, the sliding member is sat on the dispensing housing for engaging with an edge of the slide within the dispensing channel, and at the dispensing position, the sliding member is pushed to slide along the dispensing channel for pushing out the slide from the receiving cavity of the slide container.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a slide dispenser according to a preferred embodiment of the present invention.

FIG. 2 is a sectional side view of the slide dispenser according to the above preferred embodiment of the present invention.

FIG. 3 is a first alternative mode of the slide dispenser according to the above preferred embodiment of the present invention.

FIG. 4 is a second alternative mode of the slide dispenser according to the above preferred embodiment of the present invention.

FIG. 5 is an exploded perspective view of a slide dispenser according to the above preferred embodiment of the present invention.

FIG. 6A and FIG. 6B are schematic diagrams of the slide dispenser according to the above preferred embodiment of the present invention, illustrating that the sliding member is in the idle position and the dispensing position respectively.

FIG. 7 is a sectional front view of the slide dispenser according to the above preferred embodiment of the present invention.

### DETAILED DESCRIPTION OF THE PREFERRED EMBODIMENT

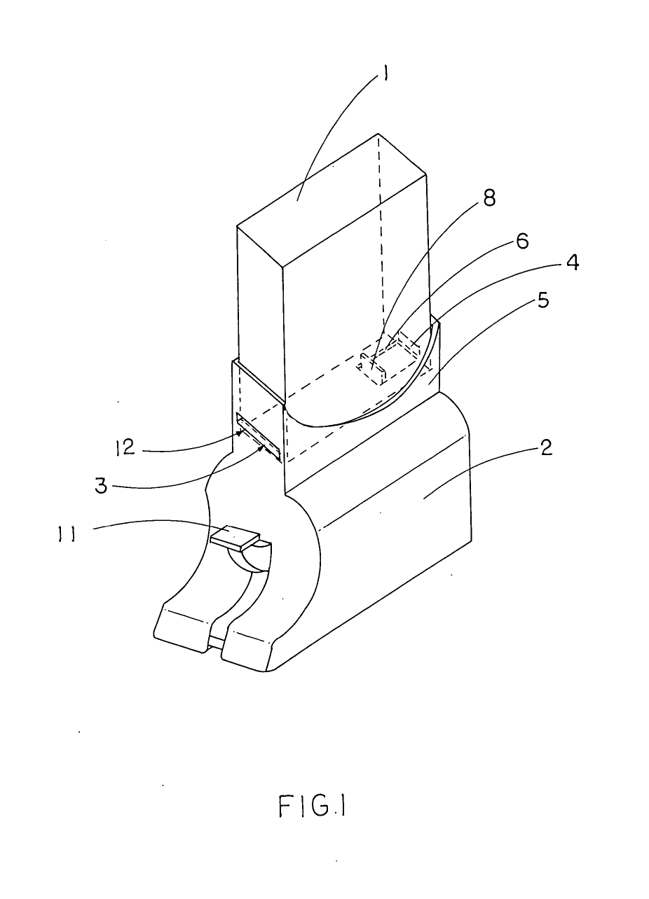

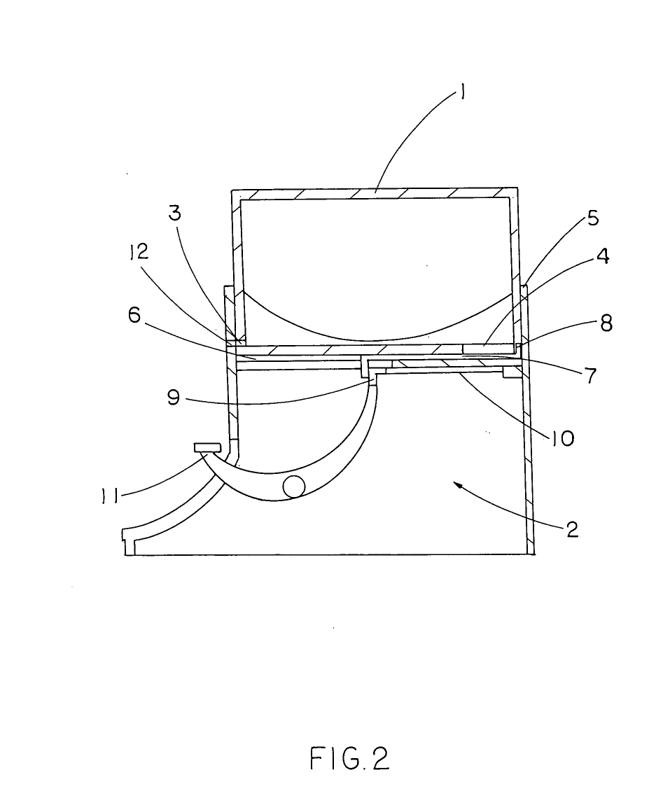

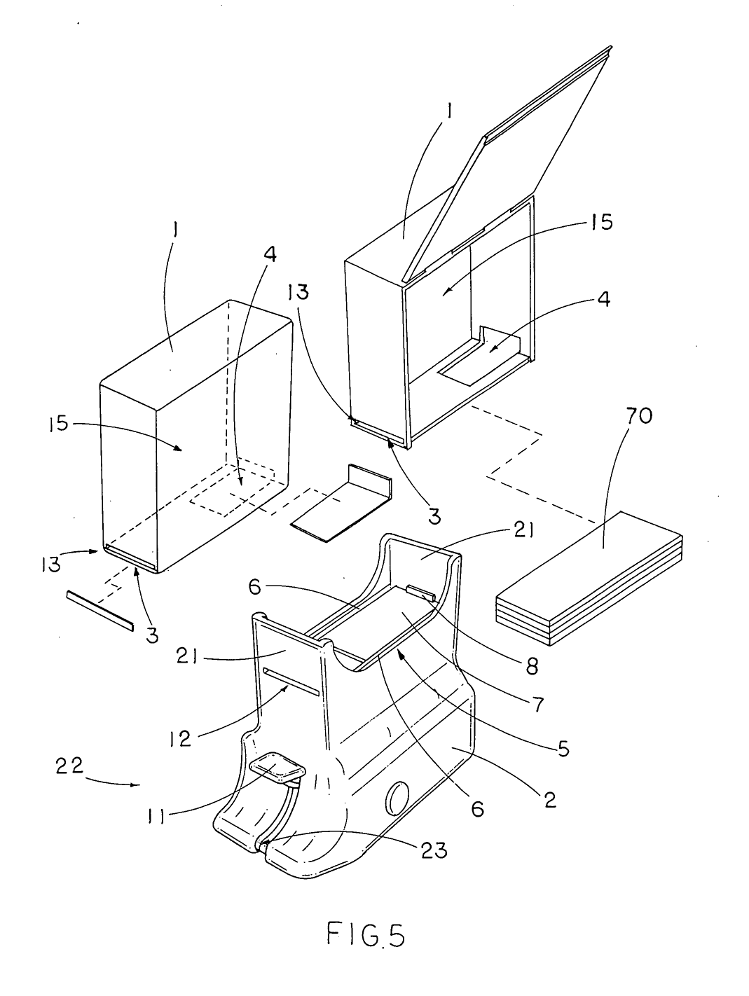

Referring to FIG. 1, FIG. 2 and FIG. 5 of the drawings, a slide dispenser for a stack of slides 70 according to a preferred embodiment of the present invention is illustrated, in which the slide dispenser comprises a slide container 1 and a slide dispensing unit. The slide container 1 has a slide opening 3 and an actuation opening 4 formed on two bottom side portions of the slide container 1 respectively, wherein the height of the slide opening 3 and the actuation opening 4 are larger than a height of a slide 70 so that the slide 70 may pass through the slide opening 3 and the actuation opening 4 smoothly. The slide dispensing unit comprises a dispensing housing 2 which comprises a front and a rear wall defining two parallel sliding tracks 6 respectively. Moreover, the slide dispensing unit further comprises an actuation unit 22 comprising a sliding member 7 slidably mounted on the dispensing housing 2 at two sliding tracks 6 in such a manner that the sliding member 7 is capable of sliding along the two sliding tracks on the dispensing housing 2. In other words, the sliding tracks 6, the sliding member 7 and two sidewalls 21 together form a supporting platform 5 for supporting the slide container 1. Furthermore, the sliding member 7 has a pusher latch 8 upwardly extended from a top surface of the sliding member 7 for slidably engaging with the actuation opening 4 of the slide container 1. Accordingly, the actuation opening 4 extends from the bottom side portion of the slide container 1 to a bottom surface thereof so that the pusher latch 8 is adapted to engage with the actuation opening 4 via the bottom side of the slide container 1 for pushing the bottommost slide 70 contained in the slide container 1. The dispensing housing 2 further comprises a resilient element 10 mounted therein for normally exerting an urging force on the sliding member 7 at a driven latch 9 downwardly extended from a bottom side of the sliding member 7. Moreover, the dispensing housing further comprises a slide actuator 11 having a dispensing end 111 movably mounted in the dispensing housing 2 at the driven latch 9, and an actuation end 112 extended to an exterior of the dispensing housing 2 in such a manner that the slide actuator 11 is adapted to drive the sliding member 7 sliding along the sliding tracks 6. It is worth mentioning that the dispensing housing 2 further has an elongated slot 12 formed thereon and substantially aligned with the sliding opening 3 when the slide container 1 is supported on the dispensing housing 2, so that the bottommost slide 70 is adapted to be pushed by the sliding member 7 out of the sliding container and the dispensing housing 2 via the sliding opening 3 and the elongated slot 12.

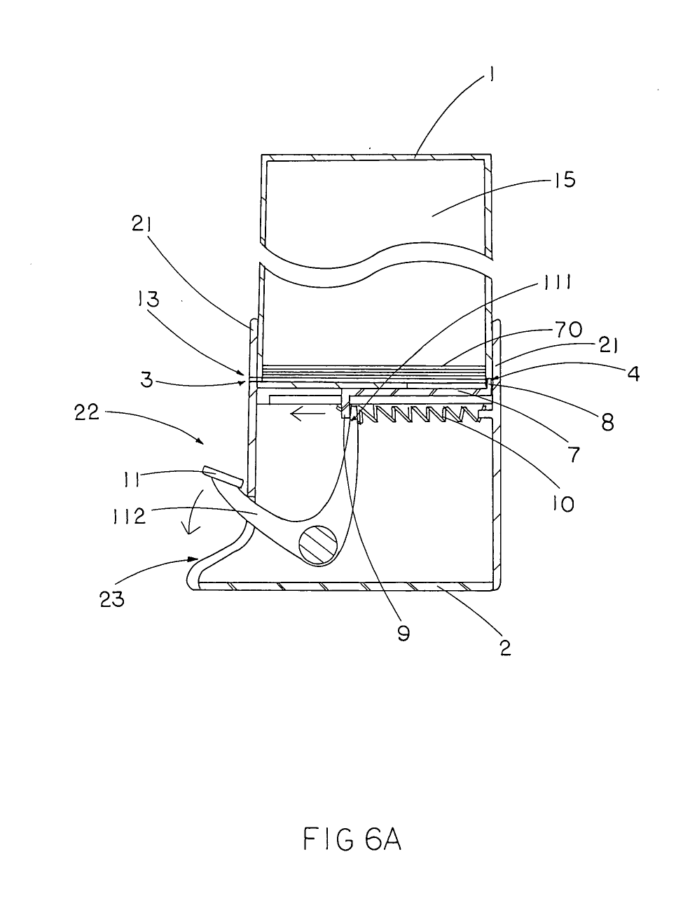

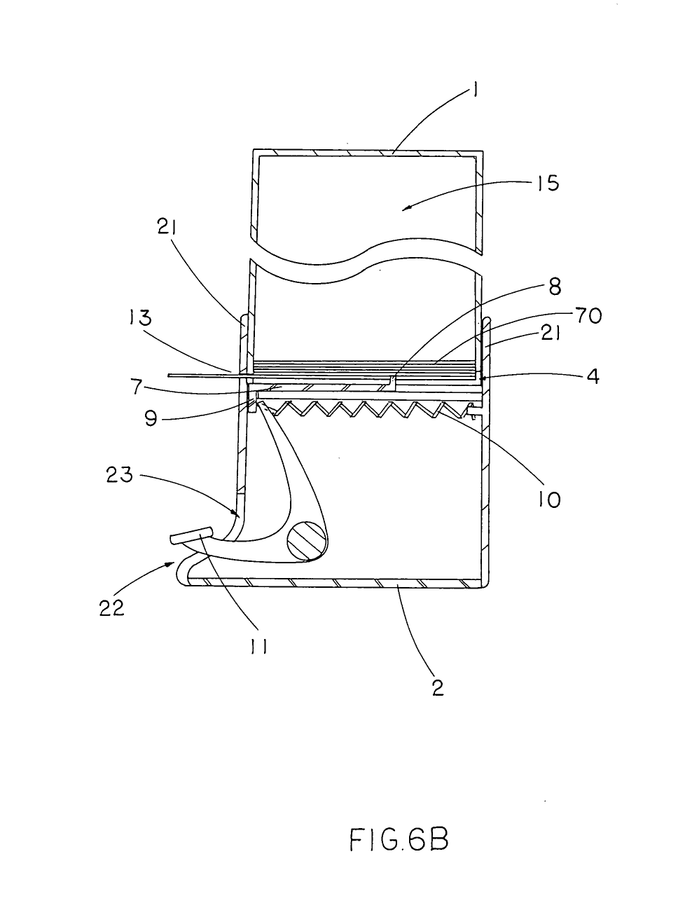

In other words, referring to FIG. 1, FIG. 2, FIG. 5, FIG. 6A and FIG. 6B of the drawings, the slide dispenser of the present invention is for a stack of slides, in which the slide container 1 has a receiving cavity 15 for receiving the stack of slides 70 in an overlapped manner. Moreover, the slide container 1 further has a dispensing channel 13 communicating with the receiving cavity 15 for allowing the slide 70 at the bottommost position to slide along the dispensing channel 13.

The dispensing housing 2 is for detachably supporting the slide container 1 thereon. The sliding member 7 of the actuation unit 22 is slidably mounted on the dispensing housing 2 to communicate with the dispensing channel 13, whereas the slide actuator 11 is movably connected to the dispensing housing 2 to move the sliding member 7 between an idle position and a dispensing position, wherein at the idle position, the sliding member 7 is sat on the dispensing housing 2 for engaging with an edge of the bottommost slide 70 within the dispensing channel 13, and at the dispensing position, the sliding member 7 is pushed to slide along the dispensing channel 13 for pushing out the slide 70 from the receiving cavity 15 of the slide container 1.

Accordingly, the dispensing channel 13 is extended at a bottom portion of the slide container 1 having the slide opening 3 and the actuation opening 4 forming the two end portions of the dispensing channel 13. When the slide container 1 is rested on the dispensing housing 2, the pusher latch 8 of the sliding member 7 is arranged to upwardly extend therefrom to engage with the actuation opening 4 for substantially aligning with an inner edge of the bottommost slide 70 contained in the slide container 1.

The elongated slot 12 is formed on one of the sidewalls 21 of the dispensing housing 2 and substantially aligned with the slide opening 3 of the slide container 1 so that when the sliding member 7 slides along the sliding tracks 6, the pusher latch 8 is driven to horizontally push the bottommost slide 70 at its inner edge for pushing an outer end portion of the slide 70 out of the dispensing housing 2 via the elongated slot 12. In other words, a width of the elongated slot 12 at least equals a width of the bottommost slide 70 so that it is capable of being dispensed out of the slide container 1 via the elongated slot 12.

According to the preferred embodiment of the present invention, the dispensing housing 2 has a quadrilateral cross section wherein the two sidewalls 21 are upwardly extended at two sides of the dispensing housing 2 respectively to form the supporting platform 5 within the two sidewalls 21 and the sliding member 7. Moreover, the supporting platform is shaped and sized to fittedly receive the slide container 1 so that when the slide container 1 is resided on the supporting platform 5, its lateral movement with respect to the dispensing housing 2 is minimized.

The resilient element 10 is preferably embodied as a conventional compressive spring normally applying a horizontal urging force at the driven latch 9 of the sliding member 7 for normally retaining the sliding member 7 at its idle position.

On the other hand, the slide actuator 11 is pivotally mounted in the dispensing housing 2 so that the actuation end 112 is adapted to be depressed for driving the dispensing end 111 of the slide actuator 11 to pivotally and tangentially move within the dispensing housing 2 wherein the tangential movement of the dispensing end 111 is adapted to drive the driven latch 9 of the sliding member 7 to slide along the sliding tracks 6 for dispensing the bottommost slide in the slide container 1. Accordingly, the dispensing housing 2 further has an actuator slot 23 formed on a side surface of the dispensing housing 2 for allowing the actuation end 112 of the slide actuator 11 to be capable of sliding along the actuator slot 23 after being depressed so as to drive the sliding member 7 sliding alone the sliding tracks 6.

According to the preferred embodiment of the present invention, the sliding tracks 6 may be embodied as conventional sliding tracks 6 which are capable of substantially guiding a sliding movement of the sliding member 7.

Referring to FIG. 6A and FIG. 6B of the drawings, the operation of the present invention is elaborated as follows: the slide container 1 is first loaded with a stack of slides 70 (the slides 70 may be sanitized) and then placed on the supporting platform 5 of the dispensing housing 2 in such a manner that the actuation opening 4 is longitudinally aligned with the pusher latch 8 of the sliding member 7, whereas the slide opening 3 is longitudinally aligned with the elongated slot 12 of the dispensing housing 2. When a user of the present invention wants to retrieve a slide 70 for use, he/she may simply need to actuate the actuation end 112 of the slide actuator 11 so that the dispensing end 111 thereof is driven to tangentially drive the sliding member 7 to slide along the sliding tracks 6. As such, the pusher latch 8 of the sliding member 7 is driven to slide accordingly at the dispensing position for pushing the bottommost slide 70 in such a way that an outer portion thereof is pushed out of the dispensing housing 2 via the elongated slot 12. The user is then able to pull out the entire slide 70 by gripping on the outer portion of that slide 70. When that slide 70 is completely pulled out of the slide container 1, those slide remaining in the slide container 1 then falls down to replace the vacancy created by the pulling out the then bottommost slide 70. When the slide actuator 11 is released of the actuation force, the resilient element 10 will exerts the urging force for driving the sliding member 7 back to its idle position. The operation continues for retrieving other slides 70 within the slide container 1. It is then easy to observe that every retrieving of the slide 70 does not substantially interfere with other slides within the slide container 1 so that they are kept to the maximum hygienic condition.

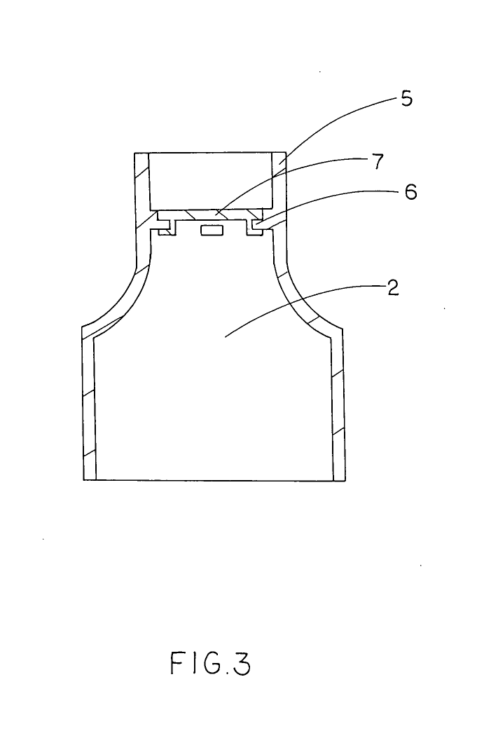

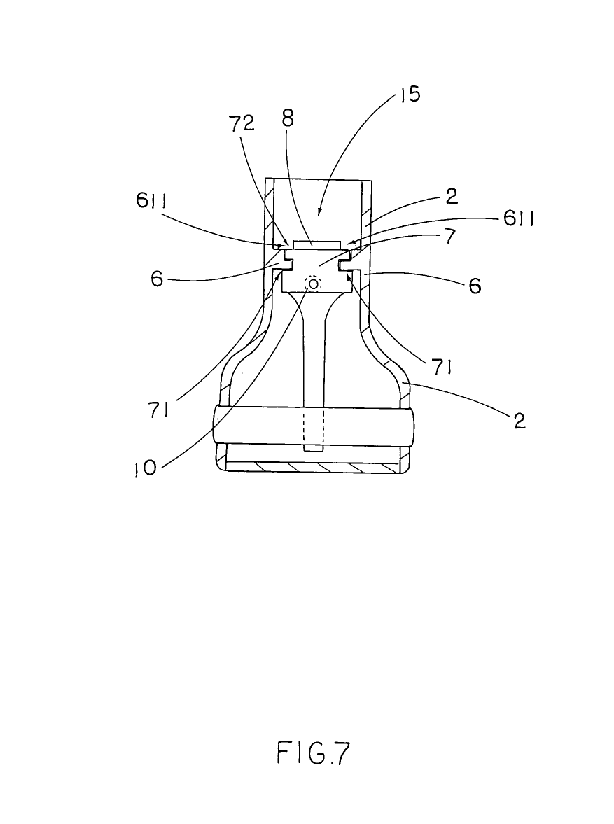

Referring to FIG. 3 and FIG. 7 of the drawings, a first alternative mode of the slide dispenser is illustrated. The first alternative mode is similar to preferred embodiment except the sliding tracks 6 and the sliding member 7. According to the first alternative mode, each of the sliding tracks 6 comprises two elongated guiders 61 and longitudinally extended along a front and a rear wall of the dispensing housing 2 for slidably supporting the supporting member 7 sliding on the supporting platform 5.

More specifically, each of the elongated guiders 61 defines a guiding shoulder 611 and two U-shaped sliding slots 71 elonagtedly formed on its two sides of the sliding member 7 respectively so that the sliding member 7 is to align with the guiding shoulders 611 for engaging thereof respectively in a slidably movable manner so as to slide along the guiding shoulders 611 while being substantially guided by the elongated guiders 61 at the supporting platform 5.

Each of the guiding shoulders 611 are embodied as having a L-shaped cross section while the sliding member 7 is slidably engaged with the L-shaped guiding shoulders 611 in such a manner that a top surface 72 of the sliding member 7 is substantially aligned with top surfaces of the sliding tracks 6 so that the slide container 1 is capable of horizontally resting on the supporting platform 5 in a stable manner.

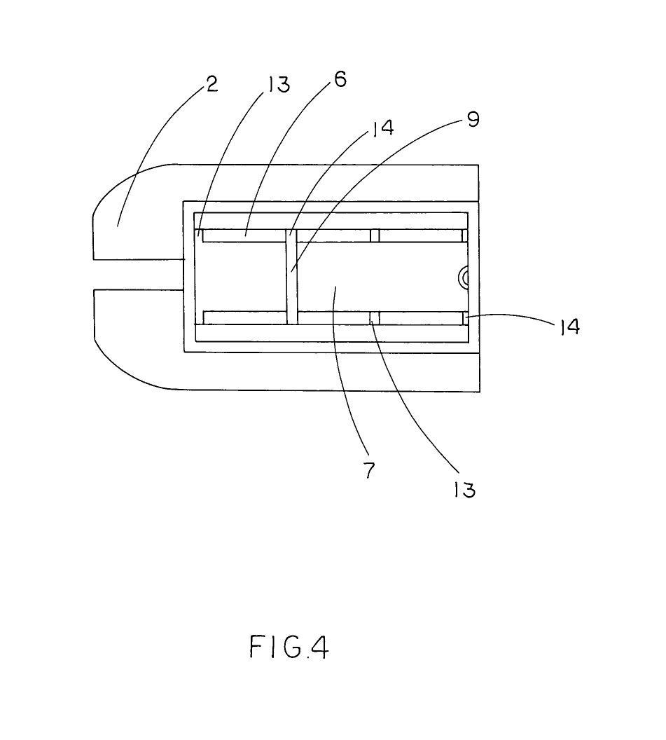

Referring to FIG. 4 of the drawings, a second alternative mode of the slide dispenser according to the first preferred embodiment of the present invention is illustrated. The second alternative mode is similar to the preferred embodiment except the sliding tracks 6 and the sliding member 7. According to the second alternative mode, each of the sliding tracks 6 has two pairs of through openings 13 whereas the sliding member 7 has two pairs of retaining members 14 downwardly extended from two sides of the sliding member 7 respectively to normally bias against a bottom surface of the sliding tracks 6. Consequently, when the sliding member 7 slides along the sliding tracks 6 in such a way that the retaining members 14 are aligned with the through openings 13 respectively, the sliding member 7 is adapted to be detached from the dispensing housing 2 for replacement or cleaning.

It is worth mentioning that, as shown in FIG. 5 of the drawings, the slide dispensing unit is adapted to fit for a wide variety of slide containers 1 so that a user may simply buy the appropriate slide container 1 with the stack of slides 70. For example, the slide container 70 may be embodied as an integral container at the actuation opening 4 and the slide opening 4. Alternatively, the slide container 1 may be made foldable so that a user may simply need to replace only the slides 70 by opening the foldable slide container 1.

From the forgoing descriptions, it can be shown that the above objects have been substantially achieved. The present invention provides a slide dispenser which is capable of storing a stack of slides in a hygienic environment while allowing easy retrieving of the slides. Thus, no longer the slides are easily re-polluted or re-infected by unwanted substances or virus so as to affect any experimental results which have been obtained through the use of any slides.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A slide dispenser for a stack of slides, comprising:
a slide container having a receiving cavity for receiving said stack of slides in an overlapped manner, and a dispensing channel communicating with said receiving cavity for allowing said slide at a bottommost to slide along said dispensing channel; and
a slide dispensing unit, which comprises:
a dispensing housing for detachably supporting said slide container thereon; and
an actuation unit which comprises a sliding member slidably mounted on said dispensing housing to communicate with said dispensing channel, and a slide actuator movably connected to said dispensing housing to move said sliding member between an idle position and a dispensing position, wherein at said idle position, said sliding member is sat on said dispensing housing for engaging with an edge of said slide within said dispensing channel, and at said dispensing position, said sliding member is pushed to slide along said dispensing channel for pushing out said slide from said receiving cavity of said slide container.

2. The slide dispenser, as recited in claim 1, wherein said sliding member has a pusher latch upwardly extended therefrom for slidably engaging with said dispensing channel of said slide container in such a manner that said pusher latch normally aligns with said bottommost slide so that when said sliding member is driven to slide from said idle position to said dispensing position, said pusher latch slides alone said dispensing channel to push said edge of said bottommost slide to slide out of said slide container via said dispensing channel.

3. The slide dispenser, as recited in claim 2, wherein said dispensing channel extends at a bottom portion of said slide container, and has a slide opening and an actuation opening forming two end portions of said dispensing channel, wherein said actuation opening extends from said bottom side portion of said slide container to a bottom surface thereof, so that when said slide container is supported on said dispensing housing, said pusher latch of said sliding member upwardly extends therefrom to engage with said actuation opening for substantially aligning with said inner edge of said bottommost slide in said slide container for slidably pushing said inner edge of said bottommost slide to slide out of said slide container via said slide opening when said sliding member slides from said idle position to said dispensing position.

4. The slide dispenser, as recited in claim 2, wherein said dispensing housing further comprises two sliding tracks longitudinally formed on a front and a rear wall of said dispensing housing respectively, wherein said sliding member is slidably engaged with said two sliding tracks for slidably moving between said idle position and said dispensing position along said sliding tracks so as to push said bottommost slide out of said slide container.

5. The slide dispenser, as recited in claim 3, wherein said dispensing housing further comprises two sliding tracks longitudinally formed on a front and a rear wall of said dispensing housing respectively, wherein said sliding member is slidably engaged with said two sliding tracks for slidably moving between said idle position and said dispensing position along said sliding tracks so as to push said bottommost slide out of said slide container.

6. The slide dispenser, as recited in claim 4, wherein said dispensing housing further has two sidewalls upwardly extended therefrom to form a supporting platform between said sidewalls and said front and said rear wall for substantially supporting said slide container, and has a through elongated slot transversely formed on one of said sidewalls and substantially aligned with said dispensing channel when said slide container is supported on said dispensing housing, so that said bottommost slide is adapted to be pushed by said sliding member out of the sliding container and said dispensing housing via said dispensing channel and said elongated slot.

7. The slide dispenser, as recited in claim 5, wherein said dispensing housing further has two sidewalls upwardly extended therefrom to form a supporting platform between said sidewalls and said front and said rear wall for substantially supporting said slide container, and has a through elongated slot transversely formed on one of said sidewalls and substantially aligned with said sliding opening when said slide container is supported on said dispensing housing, so that said bottommost slide is adapted to be pushed by said sliding member out of the sliding container and said dispensing housing via said sliding opening and said elongated slot.

8. The slide dispenser, as recited in claim 1, wherein said slide actuator, which is pivotally mounted in said dispensing housing, has a dispensing end connected to said sliding member, and an actuation end extended to an exterior of said dispensing housing in such a manner that when said actuation end is actuated, said dispensing end is pivotally driven to move tangentially for driving said sliding member horizontally sliding along said sliding tracks from said idle position to said dispensing position for pushing said bottommost slide out of said slide container.

9. The slide dispenser, as recited in claim 6, wherein said slide actuator, which is pivotally mounted in said dispensing housing, has a dispensing end connected to said sliding member, and an actuation end extended to an exterior of said dispensing housing in such a manner that when said actuation end is actuated, said dispensing end is pivotally driven to move tangentially for driving said sliding member horizontally sliding along said sliding tracks from said idle position to said dispensing position for pushing said bottommost slide out of said slide container.

10. The slide dispenser, as recited in claim 7, wherein said slide actuator, which is pivotally mounted in said dispensing housing, has a dispensing end connected to said sliding member, and an actuation end extended to an exterior of said dispensing housing in such a manner that when said actuation end is actuated, said dispensing end is pivotally driven to move tangentially for driving said sliding member horizontally sliding along said sliding tracks from said idle position to said dispensing position for pushing said bottommost slide out of said slide container.

11. The slide dispenser, as recited in claim 9, wherein each of said sliding tracks comprises two elongated guiders longitudinally extended along a front and a rear wall of said dispensing housing for slidably supporting said supporting member sliding on said sliding tracks, wherein each of said elongated guiders defines a L-shaped guiding shoulder and two U-shaped sliding slots elongatedly formed on two sides of said sliding members respectively so that said sliding member is to align with said guiding shoulders for engaging thereof in a slidably movable manner so as to slide along while being substantially guided by said elongated guiders.

12. The slide dispenser, as recited in claim 10, wherein each of said sliding tracks comprises two elongated guiders longitudinally extended along a front and a rear wall of said dispensing housing for slidably supporting said supporting member sliding on said sliding tracks, wherein each of said elongated guiders defines a L-shaped guiding shoulder and two U-shaped sliding slots elongatedly formed on two sides of said sliding members respectively so that said sliding member is to align with said guiding shoulders for engaging thereof in a slidably movable manner so as to slide along while being substantially guided by said elongated guiders.

13. A slide dispensing unit for a slide container containing a stack of slides, and having a receiving cavity for receiving said stack of slides in an overlapped manner, and a dispensing channel communicating with said receiving cavity for allowing said slide at a bottommost to slide along said dispensing channel; wherein said slide dispensing unit comprises:
a dispensing housing for detachably supporting said slide container thereon; and
an actuation unit which comprises a sliding member slidably mounted on said dispensing housing to communicate with said dispensing channel, and a slide actuator movably connected to said dispensing housing to move said sliding member between an idle position and a dispensing position, wherein at said idle position, said sliding member is sat on said dispensing housing for engaging with an edge of said slide within said dispensing channel, and at said dispensing position, said sliding member is pushed to slide along said dispensing channel for pushing out said slide from said receiving cavity of said slide container.

14. The slide dispensing unit, as recited in claim 13, wherein said sliding member has a pusher latch upwardly extended therefrom for slidably engaging with said dispensing channel of said slide container in such a manner that said pusher latch normally aligns with said bottommost slide so that when said sliding member is driven to slide from said idle position to said dispensing position, said pusher latch slides alone said dispensing channel to push said edge of said bottommost slide to slide out of said slide container via said dispensing channel.

15. The slide dispensing unit, as recited in claim 13, wherein said dispensing housing further comprises two sliding tracks longitudinally formed on a front and a rear wall of said dispensing housing respectively, wherein said sliding member is slidably engaged with said two sliding tracks for slidably moving between said idle position and said dispensing position along said sliding tracks so as to push said bottommost slide out of said slide container.

16. The slide dispensing unit, as recited in claim 14, wherein said dispensing housing further comprises two sliding tracks longitudinally formed on a front and a rear wall of said dispensing housing respectively, wherein said sliding member is slidably engaged with said two sliding tracks for slidably moving between said idle position and said dispensing position along said sliding tracks so as to push said bottommost slide out of said slide container.

17. The slide dispensing unit, as recited in claim 15, wherein said dispensing housing further has two sidewalls upwardly extended therefrom to form a supporting platform between said sidewalls and said front and said rear wall for substantially supporting said slide container, and has a through elongated slot transversely formed on one of said sidewalls and substantially aligned with said dispensing channel when said slide container is supported on said dispensing housing, so that said bottommost slide is adapted to be pushed by said sliding member out of the sliding container and said dispensing housing via said dispensing channel and said elongated slot.

18. The slide dispensing unit, as recited in claim 16, wherein said dispensing housing further has two sidewalls upwardly extended therefrom to form a supporting platform between said sidewalls and said front and said rear wall for substantially supporting said slide container, and has a through elongated slot transversely formed on one of said sidewalls and substantially aligned with said dispensing channel when said slide container is supported on said dispensing housing, so that said bottommost slide is adapted to be pushed by said sliding member out of the sliding container and said dispensing housing via said dispensing channel and said elongated slot.

19. The slide dispensing unit, as recited in claim 17, wherein said slide actuator, which is pivotally mounted in said dispensing housing, has a dispensing end connected to said sliding member, and an actuation end extended to an exterior of said dispensing housing in such a manner that when said actuation end is actuated, said dispensing end is pivotally driven to move tangentially for driving said sliding member horizontally sliding along said sliding tracks from said idle position to said dispensing position for pushing said bottommost slide out of said slide container.

20. The slide dispensing unit, as recited in claim 18, wherein said slide actuator, which is pivotally mounted in said dispensing housing, has a dispensing end connected to said sliding member, and an actuation end extended to an exterior of said dispensing housing in such a manner that when said actuation end is actuated, said dispensing end is pivotally driven to move tangentially for driving said sliding member horizontally sliding along said sliding tracks from said idle position to said dispensing position for pushing said bottommost slide out of said slide container.

21. The slide dispensing unit, as recited in claim 19, wherein each of said sliding tracks comprises two elongated guiders longitudinally extended along a front and a rear wall of said dispensing housing for slidably supporting said supporting member sliding on said sliding tracks, wherein each of said elongated guiders defines a L-shaped guiding shoulder and two U-shaped sliding slots elongatedly formed on two sides of said sliding members respectively so that said sliding member is to align with said guiding shoulders for engaging thereof in a slidably movable manner so as to slide along while being substantially guided by said elongated guiders.

22. The slide dispensing unit, as recited in claim 20, wherein each of said sliding tracks comprises two elongated guiders longitudinally extended along a front and a rear wall of said dispensing housing for slidably supporting said supporting member sliding on said sliding tracks, wherein each of said elongated guiders defines a L-shaped guiding shoulder and two U-shaped sliding slots elongatedly formed on two sides of said sliding members respectively so that said sliding member is to align with said guiding shoulders for engaging thereof in a slidably movable manner so as to slide along while being substantially guided by said elongated guiders.
